(19) United States
(12) Patent Application Publication
(10) Pub. No.: US 2016/0204863 A1
(43) Pub. Date: Jul. 14, 2016

(54) FIBER-OPTIC COMMUNICATION DEVICE AND FIBER-OPTIC COMMUNICATION SYSTEM

(71) Applicant: TRANSYSTEM INC., Hsinchu City (TW)

(72) Inventor: Lee-Chuan CHANG, Zhudong Township (TW)

(21) Appl. No.: 14/962,679

(22) Filed: Dec. 8, 2015

(30) Foreign Application Priority Data
Jan. 13, 2015 (TW) 104101104

(51) Int. Cl. H04B 10/2575; H04B 10/556

(52) U.S. Cl. CPC H04B 10/2575; H04B 10/5563

(57) ABSTRACT

A fiber-optic communication device includes a modulator, a combiner and an electronic-to-optical transducer. The modulator is to modulate a number (N) of radio-frequency carriers respectively with a number (M) of digital stream signals respectively into a number (N) of modulated signals having different central frequencies. The combiner is to receive the modulated signals, and to combine the modulated signals into a combined signal having a number (N) of different frequency components. The electronic-to-optical transducer is to receive the combined signal, and to convert the combined signal into a single-wavelength optical signal carrying a number (N) of radio frequency signals having different central frequencies.

### CROSS-REFERENCE TO RELATED APPLICATION

This application claims priority of Taiwanese Application Ho. 104101104, filed on Jan. 13, 2015.

### FIELD

The disclosure relates to a communication device and a communication system, and more particularly to a fiber-optic communication device and a fiber-optic communication system.

### BACKGROUND

FIG. 1 shows a conventional fiber-optic communication system using optical fibers in a conventional digital hub architecture. The transmission distance in the conventional fiber-optic communication system can be extended since signal loss in the optical fibers is relatively low. The conventional fiber-optic communication system includes a first communication device 91, a number (n) of second communication devices 92, and a number (n) of optical fibers 93 connected respectively to the second communication devices 92. Each of the optical fibers 93 connects the respective one of the second, communication devices 92 to the first communication device 91. The first communication device 91 is configured to perform electro-optic modulation on a number (n) of optical signals S₁₁-S₁ₙ with a number (n) of digital signals, respectively. The optical signals S₁₁-S₁ₙ have the same wavelength, and are transmitted respectively to the second communication devices 92 through the optical fibers 93, respectively. Similarly, each of the second communication devices 92 is configured to perform electro-optic modulation on a respective optical signal S₂₁-S₂ₙ with a respective digital signal. The optical signals S₂₁-S₂ₙ modulated respectively by the second communication devices 92 have the same wavelength, and are transmitted to the first communication device 91 respectively through the optical fibers 93.

Besides, in the conventional fiber-optic communication system, the first communication device 91 is required to include a number (n) of laser diodes 94 respectively for translating electrical signals into the optical signals and a number (n) of PIN diodes 95 respectively for translating the optical signals S₂₁-S₂ₙ received from the second communication devices 92 into electrical signals. Similarly, each of the second communication devices 92 includes a laser diode 96 and a PIN diode 97. In an i^{th} one of the second communication devices 92, the PIN diode 97 is to translate the corresponding optical, signal S₁₁ received from the first communication device 91 into an electrical signal, and the laser diode 96 is to translate the respective electrical signal into the respective optical signal S₂₁, where 1≦i≦n.

Accordingly, when the number of the second communication devices 92 is increased in the conventional fiber-optic communication system, not only the optical fibers 93 but also the laser diodes 94 and the PIN diodes 95 are increased in number for communication with the second communication devices 92, respectively. However, the cost of the laser diodes 94 and the PIN diodes 95 is relatively high, increasing significantly the cost of the conventional fiber-optic communication system as the number of the second communication devices 92 increases.

### SUMMARY

Therefore, an object of the disclosure is to provide a fiber-optic communication device and a fiber-optic communication system that can alleviate at least one of the drawbacks of the prior arts.

According to one aspect of the disclosure, a fiber-optic communication device includes a modulator, a combiner and an electronic-to-optic transducer. The modulator is configured to modulate a number (N) of radio-frequency carriers respectively with a number (N) of digital stream signals so as to generate respectively a number (N) of modulated signals having respective different central frequencies, where (N) is an integer greater than 1. The combiner is coupled to the modulator for receiving the modulated signals therefrom, and is configured to combine the modulated signals into a combined signal having a number (N) of different frequency components. The electronic-to-optical transducer is coupled to the combiner for receiving the combined signal therefrom, and is configured to convert the combined signal into a single-wavelength optical signal carrying a number (N) of radio frequency signals that have respective different central frequencies.

According to another aspect of the disclosure, a fiber-optic communication device includes an optical-to-electronic transducer, a signal separator and a number (M) of demodulators, where (M) is an integer greater than 1. The optical-to-electronic transducer is configured to convert a single-wavelength optical signal carrying a number (M) of radio frequency signals into a complex signal having a number (M) of different frequency components. The radio frequency signals have respective different central frequencies. The signal separator is coupled to the optical-to-electronic transducer for receiving the complex signal therefrom, and is configured to separate the complex signal into a number (M) of sub-signals each having a number (M) of different frequency components. The demodulators are coupled to the signal separator for receiving respectively the sub-signals therefrom. Each of the demodulators is configured to demodulate the respective one of the sub-signals for extracting an extracted digital signal from one of the frequency components of the respective one of the sub-signals.

According to yet another aspect of the disclosure, a fiber-optic communication system includes a first fiber-optic communication devise, a fiber-optic communication network and a plurality of second fiber-optic communication devices.

The first fiber-optic communication device includes a modulator, a combiner and an electronic-to-optical transducer. The modulator is configured to modulate a number (N) of radio-frequency carriers respectively with a number (N) of digital stream signals so as to generate respectively a number (N) of modulated signals having respective different central frequencies, where (N) is an integer greater than 1. The combiner is coupled to the modulator for receiving the modulated signals therefrom, and is configured to combine the modulated signals into a combined signal having a number (N) of different frequency components. The electronic-to-optical transducer is coupled to the combiner for receiving the combined signal therefrom, and is configured to convert the combined signal into a single-wavelength optical signal carrying a number (N) of radio frequency signals that have respective different central frequencies.

The fiber-optic communication network is coupled to the first fiber-optic communication device for transmitting a plurality of optical sub-signals divided from the single-wavelength optical signal. Each of the optical sub-signals has a number N of different frequency components.

The second fiber-optic communication devices are coupled to the first fiber-optic communication device through the fiber-optic communication network for receiving respectively the optical sub-signals of the single-wavelength optical signal. Each of the second fiber-optic communication devices includes an optical-to-electronic transducer and a processing module. The optical-to-electronic transducer is configured to receive a respective one of the optical sub-signals of the single-wavelength optical signal, and to convert the respective one of the optical sub-signals into a complex signal having a number (N) of different frequency components. The processing module is coupled to the optical-to-electronic transducer for receiving the complex signal therefrom, and is configured to extract an extracted digital signal from one of the frequency components of the complex signal that corresponds to a predetermined central frequency.

### BRIEF DESCRIPTION OF THE DRAWINGS

Other features and advantages of the disclosure will become apparent in the following detailed description of the embodiments with reference to the accompanying drawings, of which;

FIG. 1 is a block diagram of a conventional fiber-optic communication system;

FIG. 2 is a block diagram of an embodiment of a fiber-optic communication device for transmitting a signal according to this disclosure;

FIG. 3 is a block diagram of an embodiment of a fiber-optic communication device fox receiving a signal according to this disclosure;

FIG. 4 is a block diagram of a first embodiment of a fiber-optic communication system according to this disclosure;

FIG. 5 is a block diagram of a second embodiment of the fiber-optic communication system according to this disclosure; and

FIG. 6 is a block diagram of a third embodiment of the fiber-optic communication system according to this disclosure.

### DETAILED DESCRIPTION

Before the disclosure is described in greater detail, it should be noted that like elements are denoted by the same reference numerals throughout the disclosure.

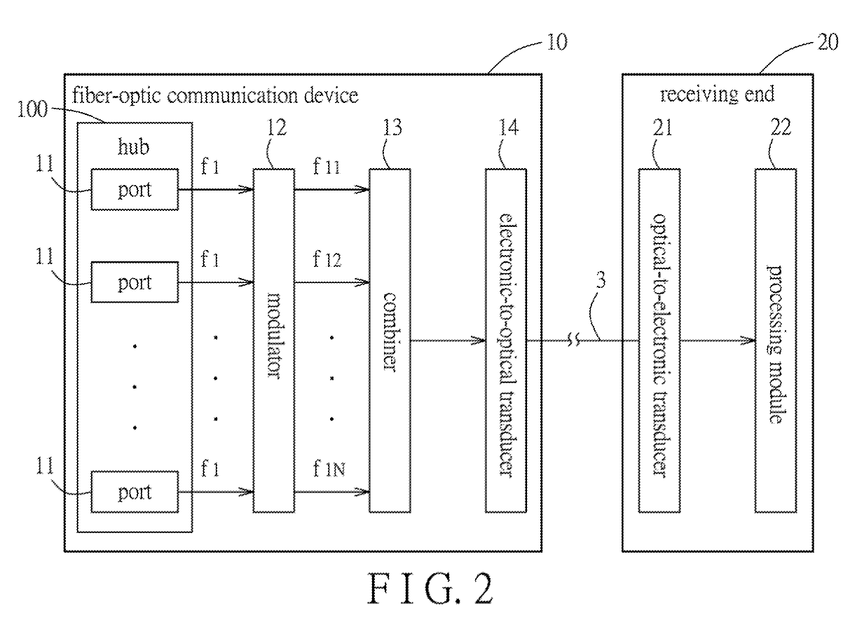

FIG. 2 shows an embodiment of a fiber-optic communication device 10 for transmitting a signal to a receiving end 20 according to the disclosure. The fiber-optic communication device 10 is coupled to the receiving end 20 through an optical fiber 3. The fiber-optic communication device 10 includes a hub 100, a modulator 12, a combiner 13 and an electronic-to-optical transducer 14.

The hub 100 includes a number (N) of ports 11, where (N) is an integer greater than one. The modulator 12 is coupled to the ports 11 for receiving a number (N) of digital stream signals having the same frequency of f₁ through the ports 11, respectively. The modulator 12 is configured to modulate a number (N) of radio-frequency carriers respectively with the digital stream, signals so as to generate respectively a number (N) of modulated signals having respective different central frequencies of f₁₁-f_{1N}. The combiner 13 is coupled to the modulator 12 for receiving the modulated signals therefrom. The combiner 13 is configured to combine the modulated signals into a combined signal having a number (N) of different frequency components. The electronic-to-optical transducer 14 is, for example, a laser diode, and is coupled to the combiner 13 for receiving the combined signal therefrom, and is further coupled to the optical fiber 3. The electronic-to-optical transducer 14 is configured to convert the combined signal into a single-wavelength optical signal carrying a number (N) of radio frequency signals that have respective different central frequencies, and to output the single-wavelength optical signal to the receiving end 20 through the optical fiber 3.

The receiving end 20 includes an optical-to-electronic transducer 21 and a processing module 22, The optical-to-electronic transducer 21 is, for example, a PIN diode, and is coupled to the optical fiber 3. The optical-to-electronic transducer 21 is configured to receive the single-wavelength optical signal from the fiber-optic communication device 10, and is configured to convert the single-wavelength optical signal into a complex signal having a number (N) of different frequency components. The frequency components of the complex signal have respective different central frequencies. The processing module 22 is coupled to the optical-to-electronic transducer 21. The processing module 22 is configured to separate at least one of the frequency components from the complex signal, and to demodulate the separated one of the frequency components for extracting therefrom an extracted digital signal that is associated with one of the digital stream signals received at the hub 100. In detail, the processing module 22 includes a frequency converter (not shown) and a filter (not shown). The frequency converter and filter are configured and designed to allows one of the frequency components of the complex signal that corresponds to a predetermined central frequency to pass therethrough. Then, the frequency converter converts said one of the frequency components passing through the filter into the extracted digital signal.

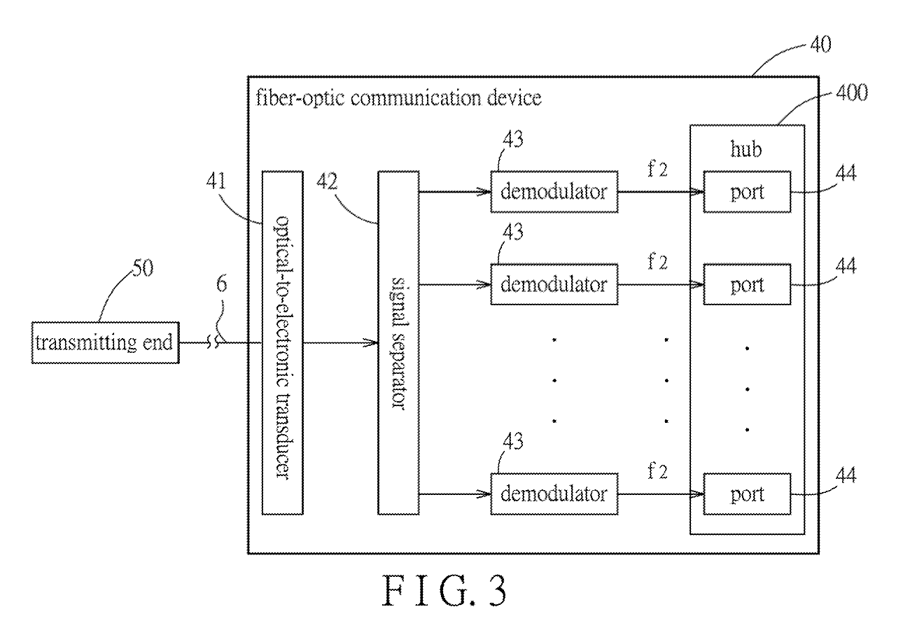

Referring to FIG. 3, an embodiment of a fiber-optic communication device 40 according to the disclosure is configured for receiving a signal from a transmitting end 50. The fiber-optic communication device 40 is coupled to the transmitting end 50 through an optical fiber 6, and includes an optical-to-electronic transducer 41, a signal separator 42, a number (M) of demodulators 43 and a hub 400, where (M) is an integer greater than one. For example, the transmitting end 50 is the fiber-optic communication device 10 shown in FIG. 2, and the fiber-optic communication device 40 of this embodiment may serve as the receiving end 20 of FIG. 2.

The optical-to electronic transducer 41 is coupled to the optical fiber 6 for receiving from, the transmitting end 50 a single-wavelength optical signal carrying a number (M) of radio frequency signals, and is configured to convert the single-wavelength optical signal into a complex signal having a number (M) of different frequency components. The signal separator 42 is coupled to the optical-to-electronic transducer 41 for receiving the complex signal therefrom. The signal separator 42 is configured to separate the complex signal into a number (M) of sub-signals each having a number (M) of different frequency components. The demodulators 43 are coupled to the signal separator 42 for receiving respectively the sub-signals from the signal separator 42, and correspond to a plurality of different default frequencies, respectively. Each of the demodulators is configured to demodulate the respective one of the sub-signals for extracting an extracted digital signal from one of the frequency components of the respective one of the sub-signals. In particular, the extracted digital signal is extracted from one of the frequency components that corresponds to the default frequency of the demodulator 43. The extracted digital signals obtained respectively by the demodulators 43 have the same frequency of f₂. For example, each demodulator 43 is configured to demodulate the respective sub-signal by decreasing frequency of the respective sub-signal. The hub 400 includes a number (M) of ports 44. The ports 44 are respectively coupled to the demodulators 43 for receiving the extracted digital signals, respectively.

For example, each of the hubs 100 and 400 is, but not limited to, a universal serial bus (USB) hub, and each of the ports 11 and 44 is a USB connection port. In other embodiments, the hubs 100 and 400 may each be a network switch, for example, an Ethernet switch.

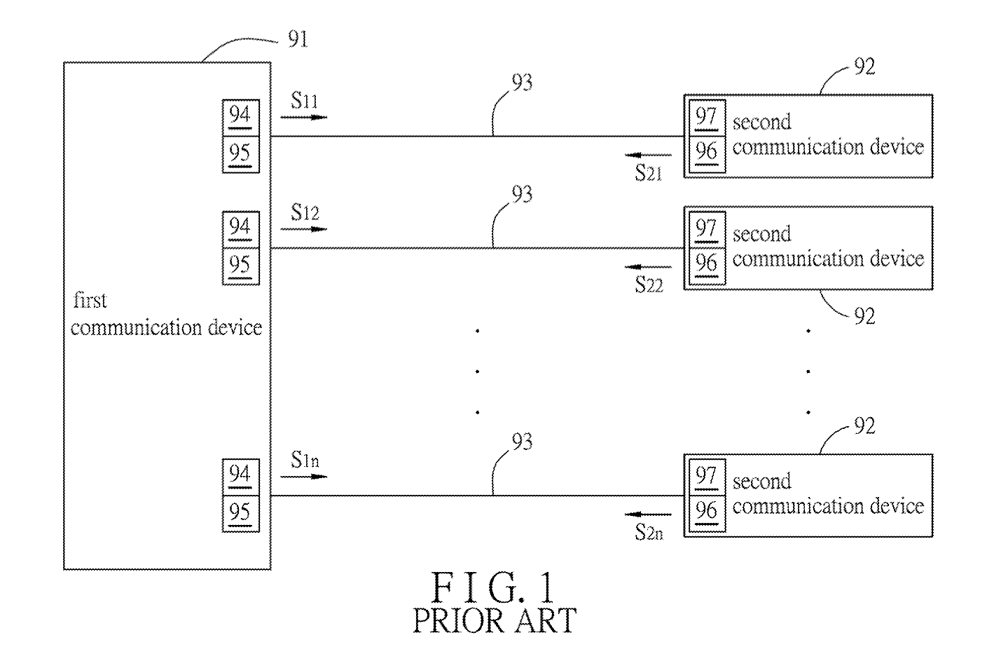

Compared to the first communication device 91 of the conventional fiber-optic communication system of FIG. 1, the modulator 12 modulates the radio-frequency carriers with the digital stream signals so as to generate the modulated signals having different central frequencies, the combiner 13 combines the modulated signals into the combined signal, and the electronic-to-optical transducer 14 converts the combined signal into the single-wavelength optical signal. Accordingly, the fiber-optic communication device 10 of FIG. 2 is capable of transmitting the single-wavelength optical signal, which indicates information in the digital stream signals, to the receiving end 20 through the single optical fiber 3. In addition, the fiber-optic communication device 10 only includes one electronic-to-optical transducer 14, and thus, the cost of the fiber-optic communication device 10 is relatively lower than the first communication device 91 which includes the number (n) of the laser diodes 94 for converting the electrical signals into the optical signals S₁₁-S₁ₙ.

Similarly, compared to the first communication device 91 of the conventional fiber-optic communication system of FIG. 1, the optical-to-electronic transducer 41 converts the single-wavelength optical signal into the complex signal, the signal separator 42 separates the complex signal into the sub-signals, and the demodulators 43 each demodulate the respective one oil the sub-signals for extracting the extracted digital signal from one of the frequency components of the respective one of the sub-signals. Accordingly, the fiber-optic communication device 40 of FIG. 3 is capable of receiving the single-wavelength optical signal, which may carry a large amount of information, from the transmitting end 50 through the single optical fiber 6. In addition, the fiber-optic communication device 40 only includes one optical-to-electronic transducer 41, and thus, the cost of the fiber-optic communication device 40 is relatively lower than the first communication device 91 which includes the number (n) of the PIN diodes 95 for converting the optical signals S₂₁-S₂ₙ into the electrical signals.

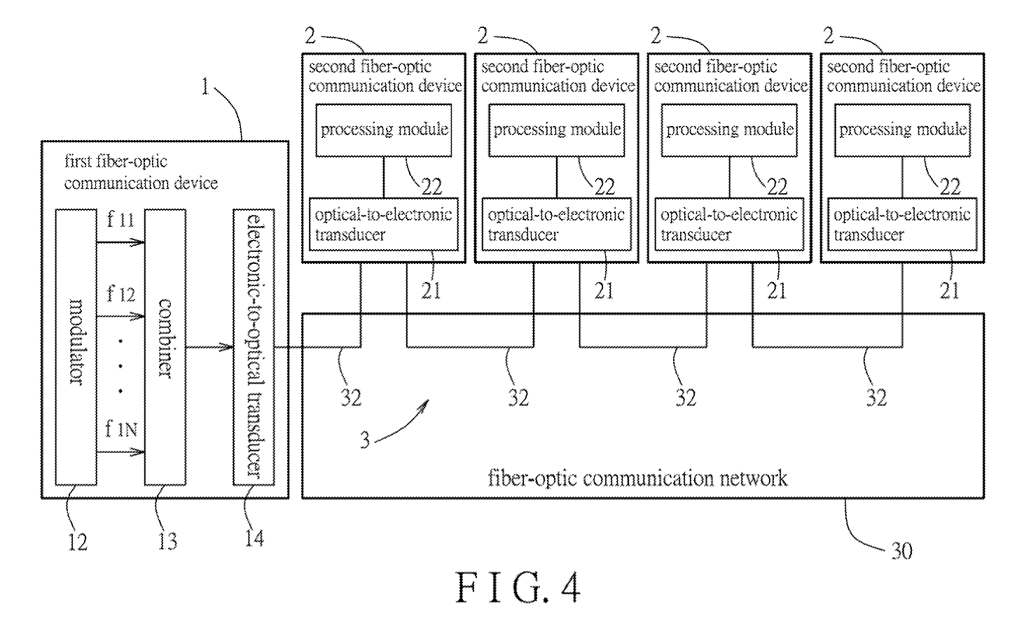

Referring to FIG. 4, a first embodiment of a fiber-optic communication system according to the disclosure includes a first fiber-optic communication device 1, a plurality of second fiber-optic communication devices 2 and a fiber-optic communication network 30. In this embodiment, the number of the second fiber-optic communication devices 2 is, but not limited to, four.

The fiber-optic communication network 30 is coupled among the first fiber-optic communication device 1 and the second fiber-optic communication devices 2, and the second fiber-optic communication devices 2 are coupled to the first fiber-optic communication device 1 through the fiber-optic communication network 30 with daisy chain topology. In this embodiment, the fiber-optic communication network 30 includes an optical fiber 3 having four segments 32. The first and second fiber-optic communication devices 1, 2 are connected in series through the optical fiber 3, and a first one of the segments 32 is coupled between the first fiber-optic communication device 1 and a first one of the second fiber-optic communication devices 2, and each of the remaining ones of the segments 32 is coupled between adjacent two of the second fiber-optic communication devices 2 in the series connection.

The first fiber-optic communication device 1 includes a modulator 12, a combiner 13 and an electronic-to-optical transducer 14. The modulator 12, the combiner 13 and the electronic-to-optical transducer 14 of the first fiber-optic communication device 1 of this embodiment are similar to those of the fiber-optic communication device 10 of FIG. 2, and details thereof will be omitted herein for the sake of brevity.

The single-wavelength optical signal outputted by the electronic-to-optical transducer 14 is transmitted through the optical fiber 3 of the fiber-optic communication network 30. In this embodiment, the fiber-optic communication network 30 is configured to divide the single-wavelength optical signal into a plurality of optical sub-signals each having a number (N) of different frequency components. The second fiber-optic communication devices 2 receive the optical sub-signals, respectively. Each of the second fiber-optic communication devices 2 is similar to the receiving end 20 of FIG. 2, and details thereof will be omitted herein for the sake of brevity.

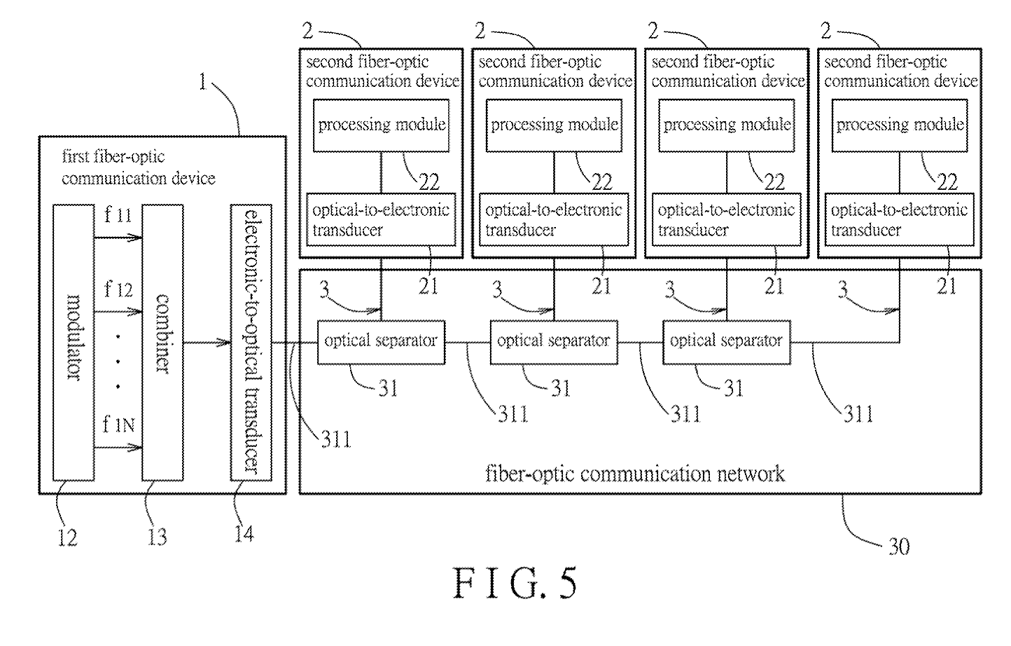

Referring to FIG. 5, a second embodiment of the fiber-optic communication system according to the disclosure is similar to the first embodiment. In the second embodiment, the second fiber-optic communication devices 2 are coupled to the first fiber-optic communication device 1 with another configuration of daisy chain topology. The fiber-optic communication network 30 includes four optical fibers 3 and three optical separators 31 for separating the single-wavelength optical signal into the optical sub-signals. In particular, one of the optical fibers 3 is coupled between the first fiber-optic communication 1 and one of the second fiber-optic communication devices 2 (i.e., the right most one in FIG. 5), and the optical separators 31 are disposed at different positions on said one of the optical fibers 3 so as to divide said one of the optical, fibers 3 into four segments 311. The remaining three of the optical fibers 3 are connected electrically and respectively to the remaining three of the second fiber-optic communication devices 2 (i.e., the left three in FIG. 5). Each of the remaining three of the optical fibers 3 electrically connects the respective one of the remaining three of the second fiber-optic communication devices 2 to a respective one of the optical separators 31. Accordingly, the single-wavelength optical signal is divided into four optical sub-signals in the fiber-optic communication network 30, and the second fiber-optic communication devices 2 receive the optical sub-signals, respectively.

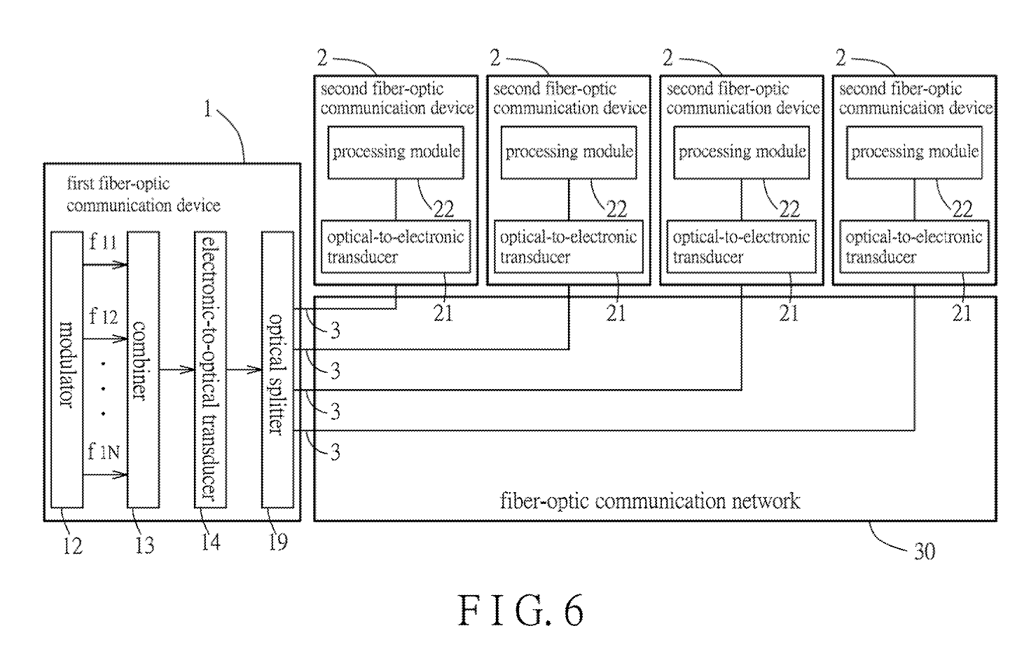

Referring to FIG. 6, a third embodiment of the fiber-optic communication system according to the disclosure is similar to the first embodiment. In the third embodiment, the second fiber-optic communication devices 2 are coupled to the first fiber-optic communication device 1 through the fiber-optic communication network 30 with star topology. The first fiber-optic communication device 1 of this embodiment is similar to that of the first embodiment of FIG. 4, and further includes an optical splitter 19 coupled to the electronic-to-optical transducer 14. The optical splitter 19 is configured to receive the single-wavelength optical signal from the electronic-to-optical transducer 14, and to split the same into the optical sub-signals. The fiber-optic communication network 30 includes four optical fibers 3 coupled to the second fiber-optic communication devices 2, respectively. Each of the optical fibers 3 electrically connects the respective one of the second fiber-optic communication devices 2 to the first fiber-optic communication device 1.

In sum, the first fiber-optic communication device 1 of the fiber-optic communication system according to the disclosure is capable of transmitting information in the digital stream signals to the second fiber-optic communication devices 2 with only one electronic-to-optical transducer 14. On the other hand, each of the second fiber-optic communication devices 2 includes only one optical-to-electronic transducer 21 for signal transmission with the first fiber-optic communication device 1. The total number of the electronic-to-optical transducer 14 and the optical-to-electronic transducers 21 in the fiber-optic communication system according to this disclosure is smaller that that of the laser diodes 94, 96 and the PIN diodes 95, 97 in the conventional fiber-optic communication system of FIG. 11 and thus, the cost of the fiber-optic communication system according to this disclosure can be lower than that of the conventional fiber-optic communication system.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A fiber-optic communication device comprising:
a modulator configured to modulate a number (N) of radio-frequency carriers respectively with a number (N) of digital stream, signals so as to generate respectively a number (N) of modulated signals having respective different central frequencies, where (N) is an integer greater than 1;
a combiner coupled to said modulator for receiving the modulated signals therefrom, and configured to combine the modulated signals into a combined signal having a number (N) of different frequency components; and
an electronic-to-optical transducer coupled to said combiner for receiving the combined signal therefrom, and configured to convert the combined signal into a single-wavelength optical signal carrying a number (N) of radio frequency signals that have respective different central frequencies.

2. The fiber-optic communication device as claimed in claim 1, further comprising a hub that includes a number (N) of ports coupled to said modulator, and that is configured to output the digital stream signals respectively through said ports to said modulator.

3. A fiber-optic communication device comprising:
an optical-to-electronic transducer configured to convert a single-wavelength optical signal carrying a number (M) of radio frequency signals into a complex signal having a number (M) of different frequency components, the radio frequency signals having respective different central frequencies, where (M) is an integer greater than 1;
a signal separator coupled to said optical-to-electronic transducer for receiving the complex signal therefrom, and configured to separate the complex signal into a number (M) of sub-signals each having a number (M) of different frequency components; and
a number (M) of demodulators coupled to said signal separator for receiving respectively the sub-signals therefrom, each of said demodulators being configured to demodulate the respective one of the sub-signals for extracting an extracted digital signal from one of the frequency components of the respective one of the sub-signals.

4. The fiber-optic communication device as claimed in claim 3, further comprising a hub that includes the number (M) of ports coupled to said demodulators, and that is configured to receive the digital stream signals from said demodulators respectively through said ports.

5. A fiber-optic communication system comprising;
a first fiber-optic communication device including
a modulator configured to modulate a number (N) of radio-frequency carriers respectively with a number (N) of digital stream signals so as to generate respectively a number (N) of modulated signals having respective different central frequencies, where (N) is an integer greater than 1,
a combiner coupled to said modulator for receiving the modulated signals therefrom, and configured to combine the modulated signals into a combined signal having a number (N) of different frequency components, and
an electronic-to-optical transducer coupled to said combiner for receiving the combined signal therefrom, and configured to convert the combined signal into a single-wavelength optical signal carrying a number (N) of radio frequency signals that have respective different central frequencies;
a fiber-optic communication network coupled to said first fiber-optic communication device for transmitting a plurality of optical sub-signals divided from the single-wavelength optical signal, each of the optical sub-signals having a number (N) of different frequency components; and
a plurality of second fiber-optic communication devices coupled to said first fiber-optic communication device through said fiber-optic communication network for receiving respectively the optical sub-signals of the single-wavelength, optical signal, each of said second fiber-optic communication devices including
an optical-to-electronic device transducer configured to receive the respective one of the optical sub-signals of the single-wave length optical, signal, and to convert the respective one of the optical, sub-signals into a complex signal having a number (N) of different frequency components, and
a processing module coupled to said optical-to-electronic transducer for receiving the complex signal therefrom, and configured to extract an extracted digital signal from one of the frequency components of the complex signal that corresponds to a predetermined central frequency.

6. The fiber-optic communication system as claimed in claim 5, wherein said second fiber-optic communication devices are coupled to said first fiber-optic communication device through said fiber-optic communication network with daisy chain topology, and said fiber-optic communication network is configured to separate the single-wavelength optical signal into the optical sub-signals.

7. The fiber-optic communication system as claimed in claim 6, wherein said fiber-optic communication network includes a plurality of optical separators for separating the single-wavelength optical signal into the optical sub-signals.

8. The fiber-optic communication system as claimed in claim 5, wherein said second fiber-optic communication devices are coupled to said first fiber-optic communication device through said fiber-optic communication network with star topology,
wherein said first fiber-optic communication device further includes an optical splitter coupled to said electronic-to-optical transducer for splitting the single-wavelength optical signal into the optical sub-signals.
